(19) United States
(12) Patent Application Publication
(10) Pub. No.: US 2005/0089001 A1
(43) Pub. Date: Apr. 28, 2005

(54) Wireless communication system, wireless communication apparatus, wireless communication method and computer program

(75) Inventor: Kenzo Nishikawa, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/940,732

(22) Filed: Sep. 15, 2004

(30) Foreign Application Priority Data
Sep. 16, 2003 (JP) P2003-322349

(51) Int. Cl. H04Q 7/24

(52) U.S. Cl. 370/338

(57) ABSTRACT

A communication station forms a multi-channel self-organized distribution type wireless network effectively without providing an unnecessary transmission pause period. The communication station refers to neighbor apparatus information described in a beacon received from a neighbor station to judge whether or not a beacon transmission channel of a corresponding next neighbor station matches a transmission scheduled channel of its own. In a case where these channels match, a transmission pause period for the next neighbor station is provided and the transmission is postponed. Accordingly, blocking against the beacon reception from the next neighbor station by the neighbor station can be avoided and provision of an unnecessary transmission pause period is not required so that the throughput is improved.

### CROSS REFERENCES TO RELATED APPLICATIONS

The present document is based on Japanese Priority Document JP 2003-322349, filed in the Japanese Patent Office on Sep. 16, 2003, the entire contents of which being incorporated herein by reference.

### BACKGROUND OF THE INVENTION

1. Field of the Invention

The present invention relates to a wireless communication system for mutual communication among a plurality of wireless stations such as a wireless LAN (Local Area Network), a wireless communication apparatus, a wireless communication method and a computer program, and more particularly to a wireless communication system, a wireless communication apparatus, a wireless communication method and a computer program, in which a wireless network is configured by ad-hoc communication without a relationship between a controlling station and a controlled station.

More in detail, the present invention relates to a wireless communication system, a wireless communication apparatus, a wireless communication method and a computer program, in which a self-organized distribution type wireless network is formed in a communication environment preparing a plurality of channels, without interference between neighboring wireless systems and without having a relationship between a controlling station and a controlled station, and more particularly to a wireless communication system, a wireless communication apparatus, a wireless communication method and a computer program, in which each communication station evade interference due to a neighbor station to form a self-organized distribution type multi-channel wireless network.

2. Description of Related Art

A wireless LAN has drawn attention as a system releasing a user from LAN wiring of a wired system. According to the wireless LAN, most of wired cables can be omitted in a workspace such as an office so that communication terminals such as personal computers can be moved relatively easily. In recent years, demands for a wireless LAN system are increasing considerably because of its high speed and low cost. Introduction of a personal area network (PAN) has been studied recently in order to perform information communication by configuring a small-scale wireless network among a plurality of electronic machines existing about each person. Different communication systems and wireless communication apparatuses have been stipulated by utilizing frequency bands requiring no license from supervisory offices, such as a 2.4 GHz band and a 5 GHz band.

As one of the standard specifications of wireless networks, IEEE (The Institute of Electrical and Electronics Engineers) 802.11 (e.g., refer to Non-patent Document 1), HiperLAN/2 (e.g., refer to Non-patent Document 2 or Non-patent Document 3), IEEE 802.15.3, Bluetooth communication and the like can be enumerated. The IEEE 802.11 standard has various wireless communication schemes such as the IEEE 802.11a standard and the IEEE 802.11b standard depending upon a difference of a wireless communication scheme and a frequency band in use.

In order to configure a local area network by using wireless technologies, a method is generally used in which one apparatus to be used as a control station called an “access point” or a “coordinator” is installed in an area and by which a network is formed under the collective control by the control station.

When information is transmitted from some communication apparatus in a wireless network having distributed access points, an access control method based on band reservation has been adopted widely by which a band necessary for transmitting the information is first reserved at an access point to use a transmission path without a collision of information transmission with other communication apparatuses. Namely, synchronous wireless communication is performed by mutually synchronizing with communication apparatuses in the wireless network by distributing access points.

In a case where asynchronous communication is to be performed between communication apparatuses on the transmission side and reception side in a wireless communication system having access points, this wireless communication requires by all means wireless communication via an access point so that there arises a problem that a transmission path use efficiency is decreased.

As another method of configuring a wireless network, “Ad-hoc communication” has been devised in which terminals perform wireless communication directly and asynchronously. It can be considered that the ad-hoc communication in which arbitrary terminals perform wireless communication directly without using a particular access point is suitable particularly for a small-scale wireless network configured by a relatively small number of clients positioned near each other.

For example, in a wireless LAN system of IEEE802.11 system, there is prepared an ad-hoc mode which operates peer to peer in a self-organized distributed manner without having a relation of a controlling station and a controlled station. In this operation mode, when a beacon transmission time comes, each terminal starts counting a random time period and in a case where it receives no beacon from another terminal by the end of the time period, it transmits a beacon.

On the other hand, in a work environment in which information machines such as personal computers (PC) are prevailing and a number of apparatuses are mixedly used in an office, it can be supposed that a plurality of networks are configured in a superposed manner with scattered communication stations. In this state, if the wireless network uses a single channel, there is no room of recovering the situations that another system intrudes during communication and that the communication quality is degraded by interference or the like.

To avoid this, a conventional wireless network system generally adopts a method by which a plurality of frequency channels are prepared for coexistence of other networks and a communication operation starts by making a wireless communication apparatus serving as an access point select one frequency channel. For example, in a standard such as IEEE 802.11h, a structure called “Dynamic Frequency Select (DFS)” for changing a channel dynamically has been examined.

The multi-channel communication scheme of this type can maintain a network operation and realize coexistence of other networks by switching a frequency channel to be used, when another system intrudes during communication or a communication quality is degraded by interference or the like.

Here, in the ad-hoc mode, each terminal starts counting a random time period when a beacon transmission time comes, and in a case where the terminal receives no beacon from another terminal by the end of the time period, the terminal itself transmits a beacon (described above).

However, such a structure cannot solve a hidden terminal problem. That is, a local station can receive a beacon only from a neighbor station as another beacon, and cannot receive a beacon from a next neighbor station. Accordingly, there may be a case where the local station and the next neighbor station transmit a beacon at the same time. In other words, as a result of a collision of the beacons from the local station and the next neighbor station, the neighbor station positioned between these stations can receive neither.

In addition, the RTS/CTS method can be adopted as means for avoiding a collision of beacons to improve communication quality. According to this communication method, a data transmitting communication station transmits a transmission request packet (request to send (RTS)) and starts data transmission in response to reception of a confirmation notice packet (clear to send (CTS)) from a data transmission destination communication station. A neighboring station that received these RTS and CTS sets a transmission pause period only for a period during which data transmission based on an RTS/CTS procedure is expected so as to evade a collision.

However, in the multi-channel communication environment, in a case where a data transmitting communication station transits to a beacon transmission channel of a data transmission destination communication station to carry out a data transmission operation, there arises an inherent hidden terminal problem. The hidden terminal problem is that, in a case where a neighboring station being a hidden terminal relative to the data transmitting communication station transmits an interference wave in the transition destination channel, the transmission destination station cannot hear an RTS signal transmitted through the transition destination channel.

Here, a system in which the neighboring stations mutually notify of information regarding whether or not beacon reception by the next neighbor station is scheduled. However, even if such a structure is introduced, since the beacon of the next neighbor station cannot be received, information as to when the beacon was actually transmitted, whether or not the channel is to be changed after the beacon transmission, or the like cannot be found.

Accordingly, in order to also avoid a collision during data transmission subsequent to the beacon transmission, it is necessary to continue carrier sensing until the transmission time of a CTS signal which is the latest within a predictable range. Even in such a case, it is not until a case of no signal that it is detected that there has been no possibility of the data portion collision.

In this way, after the beacon of the next neighbor station, a transmission pause period which is as long as possible should be provided. On the other hand, if the transmission pause period of the same time period is provided in the neighbor beacon, the transmission is suspended more than necessary so that the throughput is deteriorated. There may be a case where the transmission pause is not necessary in consideration of the beacon channels and the data channels at the beacon transmission time, it is not efficient to provide a transmission pause period of the same time length at all times.

[Non-patent document 1]

International Standard ISO/IEC 8802-11:1999(E) ANSI/IEEE Std 802.11, 1999 Edition, Part II: Wireless LAN Medium Access Control (MAC) and Physical Layer (PHY) Specification
   [Non-patent document 2]
ETSI Standard ETSI TS 101 761-1 V1.3.1 Broadband Radio Access Networks (BRAN); HIPERLAN Type 2; Data Link Control (DLC) Layer; Part 1: Basic Data Transport Functions
   [Non-patent document 3]
ETSI Standard ETSI TS 101-761-2 V1.3.1 Broadband Radio Access Network (BRAN); HIPERLAN Type 2; Data Link Control (DLC) Layer; Part 2: Radio Link Control (RLC) sublayer

### SUMMARY OF THE INVENTION

An object of the present invention is to provide an excellent wireless communication system, wireless communication apparatus, wireless communication method and computer program, which can properly configure a self-organized distribution type wireless network without having a relation between a controlling station and a controlled station and without any interference among neighbor wireless systems in a communication environment preparing a plurality of channels.

A further object of the present invention is to provide an excellent wireless communication system, a wireless communication apparatus, a wireless communication method and a computer program, in which each communication station evades an interference of a neighboring station so that a multi-channel self-organized distribution type wireless network can be formed.

A further object of the present invention is to provide an excellent wireless communication system, a wireless communication apparatus, a wireless communication method and a computer program, in which each communication station provides a transmission pause period to evade a collision in a case where data transmission from a neighboring station is expected, so that a multi-channel self-organized distribution type wireless network can be formed.

A further object of the present invention is to provide an excellent wireless communication system, wireless communication apparatus, wireless communication method and computer program, in which a communication station is capable of efficiently forming a multi-channel self-organized distribution type wireless network without providing an unnecessary transmission pause period for a communication station.

The present invention is made in view of the above-described problem, and a first aspect of the present invention provides a system for forming a network for a plurality of wireless communication apparatuses without having a relationship between a controlling station and a controlled station in a self-organized distributed manner in a communication environment provided with a plurality of channels, in which each communication station sets a transmission pause period in accordance with whether a neighboring station is a neighbor station or a next neighbor station and in accordance with a channel used at a transmission time of the neighboring station at a transmission scheduled time of the neighboring station.

The “system” used in this specification means a logical collection of a plurality of apparatuses (or functional modules realizing specific functions) and does not specifically refer to whether each apparatus or function module is accommodated in a single housing.

Here, each communication station transmits a beacon signal with neighbor apparatus information regarding a beacon transmission channel and a beacon transmission timing of the neighboring station included therein. In other words, each communication station notifies the beacon information to announce its existence for the other communication stations in a neighbor area (i.e., within a communication range) and to inform of the network configuration. A communication station newly entering in a communication range of a certain communication station can detect that it entered the communication range, by receiving a beacon signal, and can know the network configuration by analyzing information described in the beacon.

In such a case, it is possible for the communication station to determine, depending on whether or not the communication station could actually hear a beacon at a reception scheduled time of a beacon from a neighboring station, whether the transmitting station of the beacon is a neighbor station or a next neighbor station. In other words, in a case of a beacon signal from the neighbor station, it is possible to find the time receiving the beacon. On the other hand, in a case where a beacon to receive is positioned at a transmission position where the communication station cannot hear the beacon, it is found that the beacon is of the next neighbor station, that is, of a hidden terminal relative to the local station.

In addition, the RTS/CTS method can be adopted for avoiding a collision at the time of a channel access and to improve communication quality. In this case, each communication station acquires a transmission prioritized period (TPP) immediately after the beacon transmission of the local station, transmits a transmission request packet RTS to the data transmission destination, and starts data transmission in response to reception of a confirmation notice packet CTS from the communication station of the data transmission destination.

In such a case, it is possible to set a time period after reception of a beacon from the neighbor station until a reception scheduled time of a CTS signal as the transmission pause period if the communication station receives no CTS signal from the data transmission destination after receiving an RTS signal from the neighbor station. In other words, in a case where the CTS signal sent back immediately after the RTS signal is heard, the transmission should be suspended for a transmission time period defined in the CTS signal because of the possibility of a data portion collision. On the other hand, if the CTS signal sent back immediately after the RTS signal is not heard, it is found that there is no possibility of the data portion collision, and the transmission may be started.

In addition, the communication station should set a maximum transmission pause period including a maximum time of the random backoff and time required for the RTS/CTS procedure in addition to the beacon reception scheduled time in association with a scheduled beacon reception of the next neighbor station. In a case where the data is transmitted from the next neighbor station, a communication station waiting for beacon reception cannot receive the beacon actually so that it is necessary to estimate a maximum value for the transmission pause period for evading a collision with the data portion.

Moreover, the communication station is configured to set the transmission pause period in accordance with whether or not the beacon transmission scheduled channel of the next neighbor station matches with the data transmission scheduled channel of the local station at the beacon reception scheduled time of the next neighbor station. In a case where these channels match, a transmission pause period for the next neighbor station is provided and the transmission is postponed. Accordingly, blocking of the beacon reception from the next neighbor station by the neighbor station can be avoided and provision of an unnecessary transmission pause period is not required so that the throughput is improved.

In addition, when each communication station acquires the transmission prioritized period immediately after the beacon transmission of the local station, it may be configured that the beacon transmission channel is changed to carry out the data transmission.

In such a case, each communication station mutually notifies of data channel change possibility information describing possibility that the local station and/or the neighboring station changed the beacon transmission channel to carry out the data transmission. The communication station can detect possibility that the data channel is changed at the beacon transmission position of the next neighbor station for the local station referring to the data channel change possibility information contained in the received beacon from the neighbor station.

And the communication station is configured to set a maximum transmission pause period including a maximum time of a random backoff and time required for the RTS/CTS procedure in addition to the beacon reception scheduled time in association with a scheduled beacon reception of the next neighbor station which has the data channel change possibility.

Because there is a possibility that the local station becomes a hidden terminal to interfere the reception of the neighbor station at the beacon transmission time to which the data channel change possibility is indicated, the communication station sets the maximum transmission pause period and stands ready for data transmission until when there is no possibility that the CTS from the neighbor station is received.

On the other hand, at the beacon transmission scheduled time of the next neighbor station having no data channel change possibility, if the beacon transmission channel is different from the data transmission channel of the local station, there is no possibility of a collision at the time of data transmission and setting of the transmission pause period is not required.

In this way, notifying to the neighbor station of the information indicating the possibility of data transmission channel change may omit the transmission pause period in some cases. As a result, data transmission possible time is increased and throughput of the whole system is improved.

In addition, a second aspect of the present invention is a computer program written in a computer readable format so as to execute a processing for performing wireless communication on a computer system in a self-organized distributed manner in a wireless communication environment provided with a plurality of channels, the computer program characterized by including: a communication channel setting step for setting a transmission channel for a transmission signal of a local station; and a control step for controlling a communication operation on the channel set in the communication channel setting step, while setting a transmission pause period on the basis of whether a neighboring station is a neighbor station or a next neighbor station at a transmission scheduled time of the neighboring station and of a channel used at the transmission time of the neighboring station.

The computer program according to the second aspect of the present invention defines a computer program written in a computer readable format so as to realize a predetermined process on the computer system. In other words, as the computer program according to the second aspect of the present invention is installed in the computer system, a cooperative process is presented on the computer system to operate it as a wireless communication apparatus. A plurality of such wireless communication apparatuses are activated to configure a wireless network so that similar operations and effects to those of the wireless communication system according the first aspect of the present invention can be obtained.

According to the present invention, it is possible to provide an excellent wireless communication system, wireless communication apparatus, wireless communication method and computer program, which can properly configure a self-organized distribution type wireless network without having a relation between a controlling station and a controlled station and without any interference among neighbor wireless systems in a communication environment preparing a plurality of channels.

In addition, according to the present invention, it is possible to provide an excellent wireless communication system, wireless communication apparatus, wireless communication method and computer program, in which each communication station is capable of evading an interference of a neighboring station so that a multi-channel self-organized distribution type wireless network can be formed.

In addition, according to the present invention, it is possible to provide an excellent wireless communication system, wireless communication apparatus, wireless communication method and computer program, in which each communication station provides a transmission pause period to evade a collision in a case where data transmission from a neighboring station is expected, so that a multi-channel self-organized distribution type wireless network can be formed.

According to the present invention, in a communication environment of a multi-channel self-organized distribution type, it becomes unnecessary for each communication station to provide an unnecessarily long transmission pause period for avoiding a collision in data transmission. As a result, transmittable time within a transmission frame period is increased so that throughput of the entire system is improved.

Other objects, features and advantages of the present invention will become apparent from the preferred embodiments of the present invention to be described later and the detailed description given in conjunction with the accompanying drawings.

### BRIEF DESCRIPTION OF THE DRAWINGS

FIG. 1 is an example of the arrangement of communication apparatuses constituting a wireless communication system according to a preferred embodiment of the present invention;

FIG. 2 is a schematic view of a functional structure of a wireless communication apparatus operating as a communication station in the wireless network according to the embodiment of the present invention;

FIG. 3 is a view showing a beacon transmission procedure at each communication station according to the embodiment;

FIG. 4 is a new showing an example of beacon transmission timings on one channel;

FIG. 5 is a view showing definition of a packet interval;

FIG. 6 is a view showing how priority is assigned to a beacon transmitting station;

FIG. 7 is a view showing a structure of a transmission frame period (T_SF);

FIG. 8 is a view showing a structural example of a beacon signal format;

FIG. 9 is a view showing a description example of NBOI in a case where the number of using channel is one;

FIG. 10 is a view showing how a new entry station arranges own beacon transmission timing on some frequency channel in accordance with the description in NBOI, while avoiding a collision with already existing beacons;

FIG. 11 is a view showing a state where a new entry station sets a beacon transmission timing substantially at the middle of a beacon interval;

FIG. 12 is a view schematically showing a structure of a wireless communication system of a multi-channel structure;

FIG. 13 is a view showing a state where only four communication stations A-D are present in a communication area and a communication station A selects a transmission channel;

FIG. 14 is a view showing a state where the communication stations A-D arrange the beacon transmission timing on each channel in a multi-channel communication system composed of four channels of channel 1 to channel 4;

FIG. 15 is a view showing the beacon position information in a case of the beacon transmission time and relative channel arrangement as shown in FIG. 14;

FIG. 16 is a view showing an example of beacon arrangement of each communication station on the multiple channels;

FIG. 17 is a view for explaining a transmission pause period in a case where a beacon to receive is of a neighbor station;

FIG. 18 is a view for explaining the transmission pause period in a case where a beacon to receive is of a next neighbor station;

FIG. 19 is a view showing a state where the communication station carries out data transmission on the channel 1 and interferes the data reception of the neighbor station when the neighbor station receives data from the next neighbor station on the channel 1;

FIG. 20 is a flowchart showing a processing procedure for setting the transmission pause period in accordance with a scheduled beacon reception from the neighboring station performed by the communication station; and

FIG. 21 is a view for explaining a system for setting the transmission pause period on the basis of data channel change possibility information performed by the communication station.

### DESCRIPTION OF PREFERRED EMBODIMENTS

The preferred embodiments of the present invention will be described in detail with reference to the drawings.

A. System Configuration

Communication transmission paths assumed in the present invention are wireless, and a network is configured among a plurality of communication stations by using transmission media constituted of a plurality of frequency channels. Communication assumed in the present invention is traffics of a storage switch type, and information is transferred in the unit of a packet.

A wireless network system according to the present invention has a self-organized distribution type system structure not disposing a coordinator, and executes a transmission control effectively utilizing a plurality of channels by using a transmission (MAC) frame having a loosely synchronized time division multiple access structure. Each communication station can execute ad-hoc communication for direct and asynchronous information transmission in accordance with an access procedure based on Carrier Sense Multiple Access (CSMA).

In the wireless communication system not disposing a control station as described above, that is, a system without having a relationship between a controlling station and a controlled station, each communication station notifies beacon information to make another communication station in the neighbor (i.e., in a communication range) know the existence of the communication station, and informs of a network configuration. A communication station newly entering in a communication range of a certain communication station can detect that it entered the communication range, by receiving a beacon signal, and can know the network configuration by analyzing information described in the beacon. Since the communication station transmits a beacon at the head of a transmission frame period, the transmission frame period at each channel used by each communication station is defined by a beacon interval.

In a self-organized distribution type wireless communication system, the RTS/CTS method is adopted as means for avoiding a collision to improve communication quality and a neighboring station which received the RTS or CTS can evade a collision by setting a transmission pause period for the local station only for a period during which data transmission based on the RTS/CTS procedure is expected. However, in a case of the multi-channel self-organized distribution type network, an inherent hidden terminal problem arises. In this case, if a maximum length transmission pause period is provided, the transmission is paused more than necessary so that the throughput is deteriorated.

Accordingly, in the present embodiment, taking the beacon channels and the data channels into consideration, the transmission pause period is effectively provided so as to improve the efficiency of the network operation and to realize improvement of the throughput. The details of the construction will be described later.

The process to be executed at each communication station to be described hereunder is fundamentally a process to be executed by all communication stations participating in the ad-hoc network of the present invention. However, in some cases, not all the communication stations constituting the network execute the process to be described hereunder.

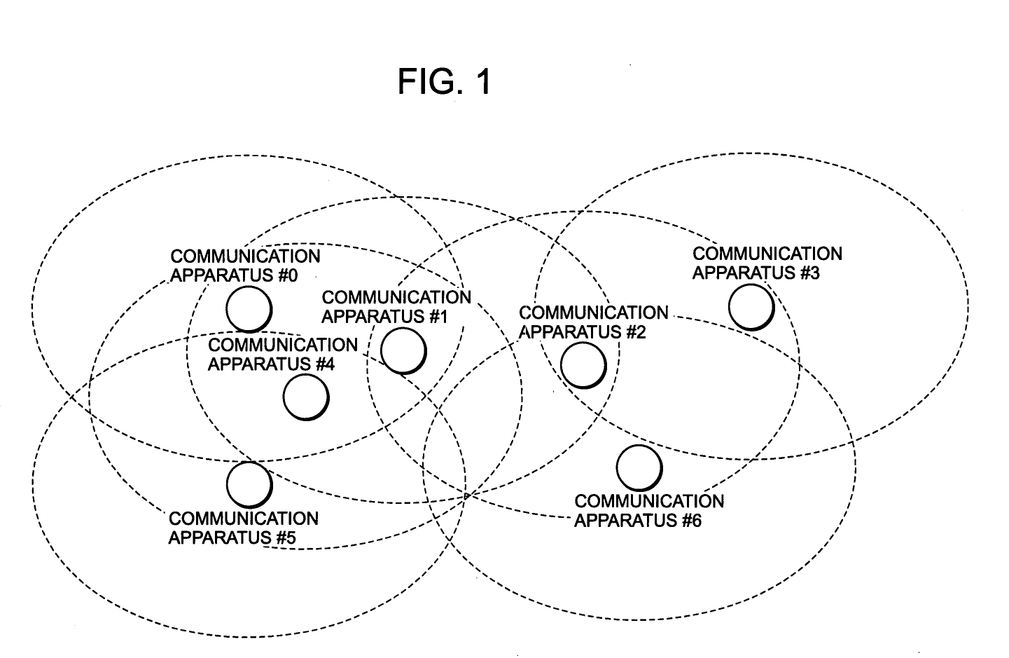

FIG. 1 shows an example of the arrangement of communication apparatuses constituting a wireless communication system according to a preferred embodiment of the present invention. In this wireless communication system, a particular control station is not disposed and each communication apparatus operates in a self-organized and distributed manner to configure the ad-hoc network. FIG. 1 shows a state that communication apparatuses #0 to #6 are distributed in the same space.

A communication range of each communication apparatus is indicated by a broken line in FIG. 1, and defined as not only the range in which communication with other communication apparatuses are possible but also the range that a signal transmitted from the station itself interferes. Namely, the communication apparatus #0 is in the range capable of communicating with the neighbor communication apparatuses #1 and #4, the communication apparatus #1 is in the range capable of communicating with the neighbor communication apparatuses #0, #2 and #4, the communication apparatus #2 is in the range capable of communicating with the neighbor communication apparatuses #1, #3 and #6, the communication apparatus #3 is in the range capable of communicating with the neighbor communication apparatus #2, the communication apparatus #4 is in the range capable of communicating with the neighbor communication apparatuses #0, #1 and #5, the communication apparatus #5 is in the range capable of communicating with the neighbor communication apparatus #4, and the communication apparatus #6 is in the range capable of communicating with the neighbor communication apparatus #2.

While communication is performed between particular communication apparatuses, there is a communication apparatus, i.e., a “hidden terminal” which one partner communication apparatus can hear but another partner communication apparatus cannot hear.

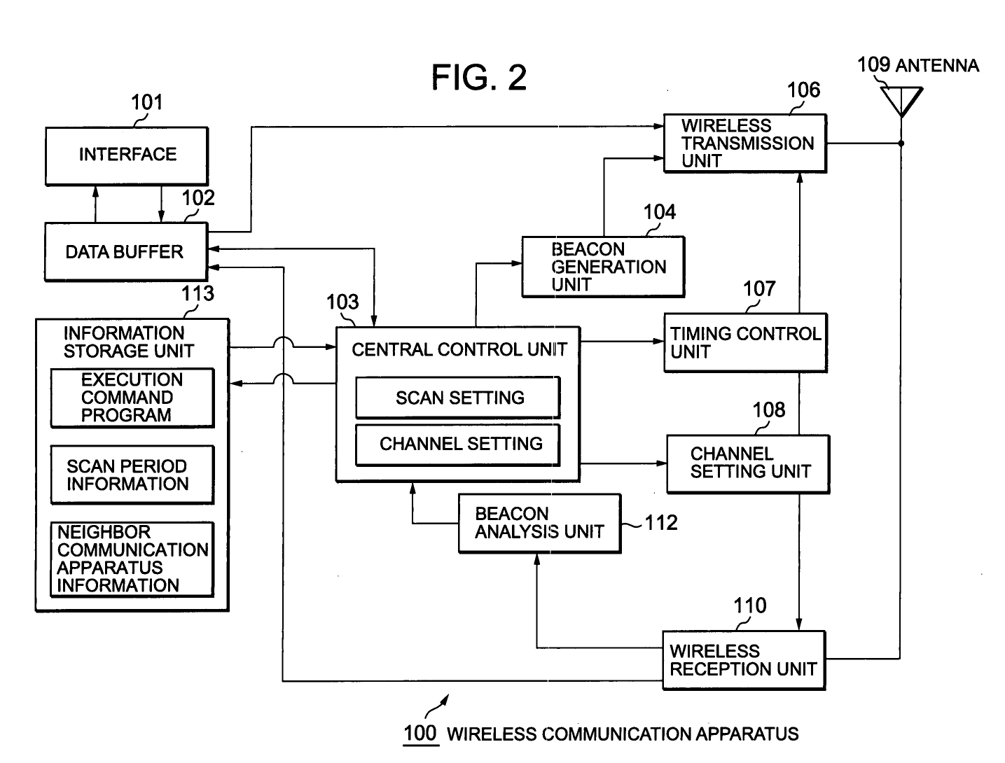

FIG. 2 is a schematic diagram of a functional structure of a wireless communication apparatus 100 operating as a communication station in the wireless network according to a preferred embodiment of the present invention. The wireless communication apparatus 100 shown in FIG. 2 can form a self-organized distributed network without interfering another wireless system by effectively performing a channel access in the same wireless system.

As shown in the figure, the wireless communication apparatus 100 is constituted of an interface 101, a data buffer 102, a central control unit 103, a beacon generation unit 104, a wireless transmission unit 106, a timing control unit 107, a channel setting unit 108, an antenna 109, a wireless reception unit 110, a beacon analysis unit 112 and an information storage unit 113.

The interface 101 exchanges various information with an external apparatus (e.g., a personal computer (not shown) or the like) connected to the wireless communication apparatus 100.

The data buffer 102 is used for temporarily storing data sent from an apparatus connected via the interface 101 or data received via a wireless transmission path, before the data is sent out via the interface 101.

The central control unit 103 collectively manages a series of information transmission and reception processes at the wireless communication apparatus 100 and performs an access control of each transmission path (scan setting, channel setting and the like in multiple channels).

The beacon generation unit 104 generates a beacon signal to be periodically exchanged with neighbor wireless communication apparatuses in the neighbor. In order for the wireless communication apparatus 100 to run the wireless network, own beacon transmission slot position of each channel, own reception slot position of each channel, a reception slot position of a beacon from a neighbor communication apparatus of each channel, and own scan operation period of each channel are stipulated. This information is stored in the information storage unit 113 and written in the beacon signal to notify it to a neighbor wireless communication apparatus. The structure of a beacon signal will be later described. Since the wireless communication apparatus 100 transmits a beacon at the start of a transmission frame period, the transmission frame period of each channel used by the wireless communication apparatus 100 is defined by the beacon interval.

The wireless transmission unit 106 performs a predetermined modulation process in order to wirelessly transmit data and a beacon signal temporarily stored in the data buffer 102.

The antenna 109 transmits signals through a selected frequency channel to another wireless communication apparatus, or collects signals transmitted from other wireless communication apparatuses. The present embodiment is configured to have a single antenna and not to perform transmission and reception parallely. Moreover, the embodiment is configured not to be able to handle a plurality of frequency channels at the same time.

The wireless reception unit 110 executes a process of receiving a signal of information and beacon sent from another wireless communication apparatus at a predetermined time. As a wireless transmission and reception method for the wireless transmission unit 106 and the wireless reception unit 110, for example, various communication methods suitable for relatively near distance communication applicable to a wireless LAN may be applied. Specifically, a UWB (Ultra Wide Band) method, an OFDM (Orthogonal Frequency Division Multiplexing) method, a CDMA (Code Division Multiple Access) method or the like can be adopted.

The channel setting unit 108 selects a channel used at the time when a wireless signal of a multi-channel type is actually transmitted and received.

The timing control unit 107 controls timing for transmitting and receiving a wireless signal on the channel set in the channel setting unit 108. For example, the timing control unit 107 controls its own beacon transmission timing at the head of a transmission frame period in a beacon transmission channel, beacon reception timing from other communication apparatus in each channel, data transmission/reception timing to and from the other communication apparatus, a scan operation period in each channel, and the like.

The beacon analysis unit 112 analyzes a beacon signal which was able to be received from the neighbor station to analyze existence and the like of another neighbor wireless communication apparatus. For example, information such as a beacon reception timing of a neighbor station, initial channel information, a neighbor beacon reception timing is stored to the information storage unit 113 as neighbor apparatus information.

The information storage unit 113 stores execution procedure commands (programs for performing scan setting, channel setting and the like) of a series of access control operations and the like to e executed by the central control unit 103, beacon transmission timing of other communication stations, neighbor apparatus information and the like.

B. Access Operation on a Channel

In this embodiment, in the communication environment provided with a plurality of channels and without having a relationship between a controlling station and a controlled station, the wireless communication apparatus 100 operating as a communication station performs a transmission control by effectively using a plurality of channels by a transmission (MAC) frame having a loosely synchronized time division multiplex access structure or a communication operation such as a random access based on CSMA/CA.

Each communication station notifies beacon information on a specific channel at a predetermined time interval to let another communication station in the neighbor (i.e., in a communication range) know the existence of the communication station, and informs of a network configuration. A communication station newly entering in a communication range of a certain communication station can detect that it entered the communication range, by receiving a beacon signal, and can know the network configuration by analyzing information written in the beacon. A beacon transmission channel is set by the channel setting unit 108.

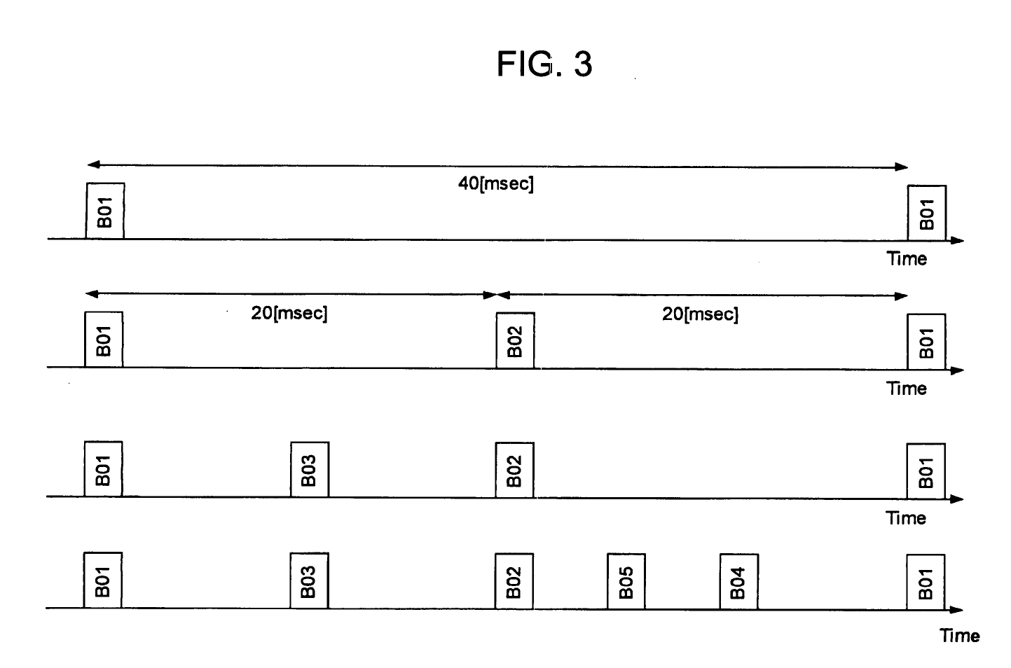

A beacon transmission procedure at each communication station according to this embodiment will be described with reference to FIG. 3. It is noted that a case where beacons of each communication station are arranged on a single channel will be explained first herein.

Assuming that information capable of being transmitted by a beacon is 100 bytes, the time taken to transmit it is 18 μs. Since one transmission is executed every 40 ms, a media occupying factor by a beacon at each communication station is as sufficiently small as one 2222-nd.

Each communication station synchronizes loosely while hearing a beacon transmitted in a neighboring area. When a new communication station appears, the new communication station sets own beacon transmission timing so as not to collide with the beacon transmission timings of already existing communication stations.

If there is no communication station in the neighboring area, a communication station 01 can start transmitting a beacon. A beacon transmission interval is 40 ms (described already). In an example of the uppermost stage shown in FIG. 2, B01 indicates the beacon transmitted from the communication station 01.

A communication station newly entering the communication range thereafter sets own beacon transmission timing so as not to collide with the arrangement of already existing beacons. In this case, since each communication station acquires a transmission prioritized period (TPP) immediately after beacon transmission, it is preferable that beacon transmission timings of respective communication stations are not congested but are uniformly distributed on a single channel from the viewpoint of a transmission efficiency. Therefore, in this embodiment, fundamentally a beacon transmission starts at approximately the middle of the longest beacon interval in the range where own station can hear it.

It is assumed, for example, that a new communication station 02 appears on a channel that only the communication station 01 exists as shown in the uppermost stage of FIG. 3. In this case, the communication station 02 receives the beacon from the communication station 01 to recognize its existence and a beacon position, and as shown at the second stage of FIG. 3, sets own beacon transmission timing at approximately the middle of the beacon interval of the communication station 01 to start beacon transmission.

It is assumed that another new communication station 03 appears. In this case, the communication station 03 receives at least one of the beacons transmitted from the communication station 01 and the communication station 02 to recognize the existence of these already existing communication stations. As shown at the third stage of FIG. 3, transmission starts at approximately the middle of the interval of beacons transmitted from the communication station 01 and the communication station 02.

Subsequently, each time a new communication station participates in a neighboring area in accordance with the similar algorithm, the beacon interval is narrowed. For example, as shown at the lowermost stage of FIG. 3, a communication station 04 appearing next sets the beacon transmission timing at approximately the middle of the beacon interval set by the communication station 02 and the communication station 01, and a communication station 05 appearing second next sets the beacon transmission timing at generally the middle of the beacon interval set by the communication station 02 and the communication station 04.

A minimum beacon interval Bmin is defined so that the band (transmission frame period) is not made in excess of beacons. Two or more beacon transmission timings are not permitted to be set in Bmin. For example, if the minimum beacon interval Bmin is defined to be 2.5 ms in the transmission frame period of 40 ms, sixteen communication stations can be accommodated at a maximum in the range where radio waves can reach.

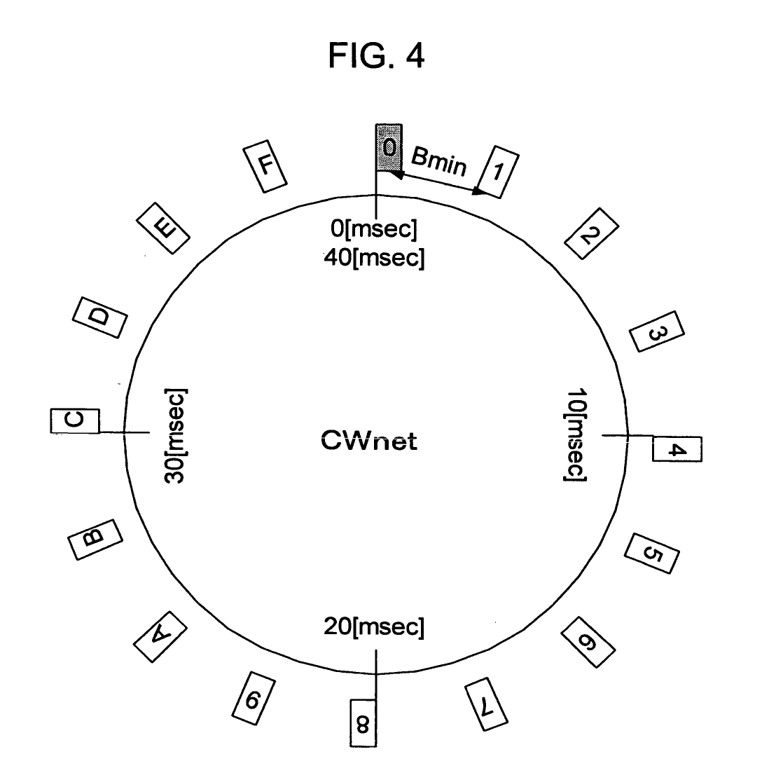

FIG. 4 shows an example of beacon transmission timings in a single channel. In this example shown in FIG. 4, a lapse of time in the transmission frame period of 40 ms is drawn as a clock whose hands move on a ring in a clockwise direction.

In the example shown in FIG. 4, sixteen communication stations 0 to F constitute nodes of the network. As described with reference to FIG. 3, it is assumed that beacons are disposed in accordance with the algorithm that beacon transmission timings of new entry stations are sequentially set at approximately the middle of a beacon interval set by already existing communication stations. If Bmin is set to 2.5 ms, communication stations more than sixteen by Bmin cannot participate in the network.

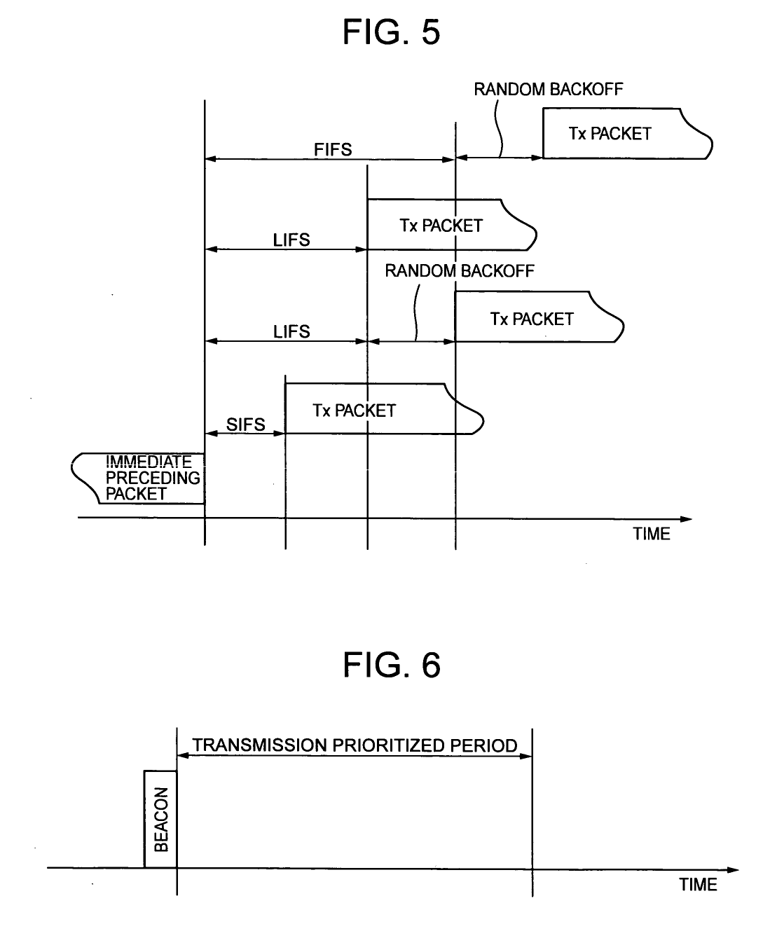

Similar to the IEEE 802.11 method or the like, also in this embodiment a plurality of packet intervals are defined. The definition of a packet interval will be described with reference to FIG. 5. Defined for the packet interval are Short Inter Frame Space (SIFS) and Long Inter Frame Space (LIFS). Only those packets given a higher priority are allowed to be transmitted at the SIFS packet interval, and the other packets are allowed to be transmitted after is it confirmed that media are cleared by a packet interval of LIFS+ a random backoff whose value is determined randomly. As a method of calculating a random backoff value, a method known in already existing techniques may be applied.

Also in this embodiment, in addition to the above-described packet intervals “SIFS” and “LIFS+backoff”, the “LIFS” and “FIFS+backoff” (FIFS: Far Inter Frame Space” are defined. Although the “SIFS” and “LIFS+backoff” are generally applied, in the time period while some communication station is given a transmission priority, other stations use the packet interval “FIFS+backoff” and the station given the priority uses the packet interval SIFS or LIFS.

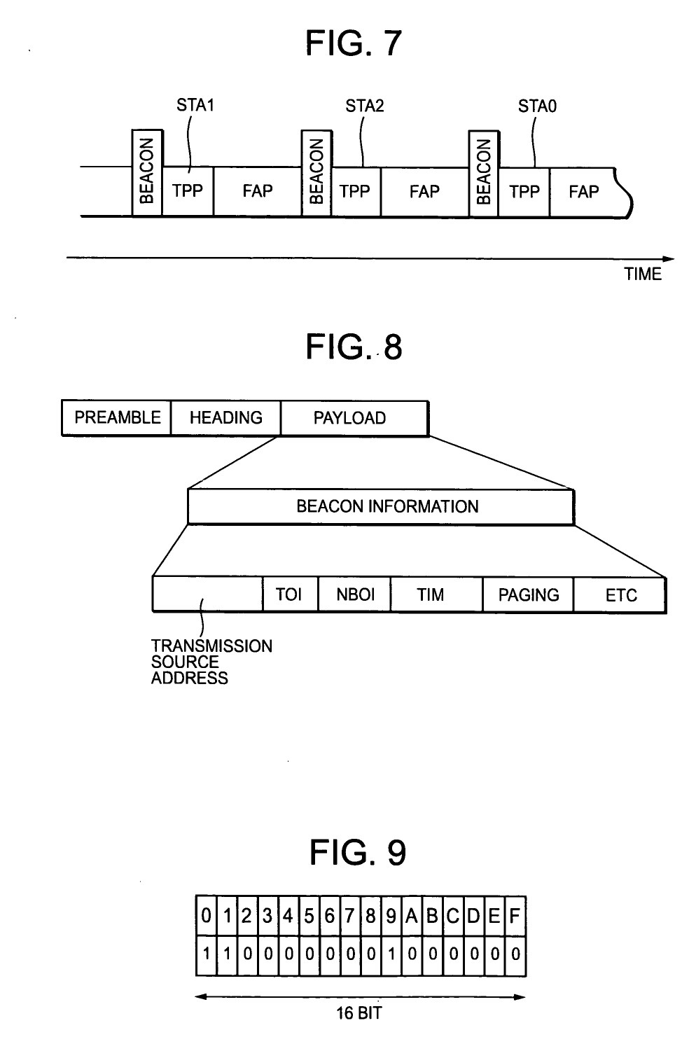

Although each communication station transmits beacons at a constant interval, the station transmitted the beacon is assigned a transmission priority during some period after the beacon is transmitted. FIG. 6 shows how the priority is assigned to the station transmitted a beacon. In the present specification, this priority period is defined as Transmission Prioritized Period (TPP). In addition, the period other than TPP is defined as Fairly Access Period (FAP), and communication is performed between communication stations according to the CSMA/CA method. FIG. 7 shows a structure of a transmission frame period (T_SF). As shown in FIG. 7, after the communication station transmits a beacon, TPP is assigned to the communication station transmitted the beacon, and after the lapse of time corresponding to the length of TPP, FAP enters which is terminated when a next communication station transmits a beacon. In this example, although TPP starts immediately after the beacon is transmitted, the invention is not limited to this. For example, the start time of TPP may be set to a relative position (time) from the beacon transmission time.

The packet interval on one channel is studied again as in the following. Each communication station executes transmission at the interval of LIFS+backoff in the FAP period. Beacon and packet transmissions in TPP of own station are permitted at the SIFS interval. Packet transmission in TPP of own station is also permitted at the LIFS interval. Packet transmission in TPP of another station is performed at the interval of FIFS+backoff. In the IEEE 802.11 scheme, although the packet interval is always FIFS+backoff, in the structure of the present embodiment, the interval can be shortened so that a packet can be transmitted more efficiently.

In the above description, although only the communication station in TPP is assigned the prioritized transmission privilege, the prioritized transmission privilege is also assigned to a communication station called by the communication station in TPP. In TPP, transmission is fundamentally made preferentially. However, if there is no information to be transmitted from own communication station and another communication station has information to be transmitted to own communication station, then a Paging message or a Polling message may be sent to the “other station”.

On the contrary, if own station has no information to be transmitted although the beacon was transmitted and own station does not know that another station has information to be transmitted to own station, then this own station carries out no communication operation and does not transmit any information and discards the transmission priority given in TPP. The other station starts transmission after the lapse of LIFS+backoff or FIFS+backoff even in this time period.

By considering the structure that TPP follows immediately after a beacon is transmitted as shown in FIG. 7, it is more preferable in terms of a transmission efficiency that the beacon transmission timings of each communication station are not congested but are uniformly distributed in the transmission frame period. Therefore, in this embodiment, fundamentally a beacon transmission starts at approximately the middle of the longest beacon interval in the range where own station can hear it. It is of course there is a method by which beacon transmission timings of respective communication stations are arranged in a concentrated manner, and during the remaining transmission frame period, the reception operation is stopped to reduce the consumption power.

FIG. 8 shows an example of the structure of a beacon signal format. As shown in FIG. 8, a beacon signal has a preamble for notifying the existence of the signal, followed by a heading and a payload field PSDU. The heading field describes the information that the packet is the beacon. Information desired to be notified by the beacon, as follows, is described in the PSDU.
TX.ADDR: a MAC address of a transmission station (TX)
TOI: a TBTT offset indicator (TBTT Offset Indicator)
NBOI: neighbor beacon offset information
TIM: a traffic indication map
PAGE: paging

TIM is annunciation information representative of that this communication station has presently information to be destined to which communication station. By referring to TIM, a reception station can recognize that the information is required to be received. Moreover, Paging is a field indicating that the field is scheduled to be transmitted in the TPP immediately after the time among the reception stations inserted in the TIM. A station specified by the field should prepare the reception at the TPP. The other field (ETC field) is also prepared.

NBOI is information describing a beacon arrangement of a neighbor communication station in a transmission frame on a channel. In this embodiment, sixteen beacons can be disposed at each channel and in the transmission frame period at a maximum. Therefore, NBOI is structured as a 16-bit length field corresponding to each beacon position, and the information of the arrangement of beacons capable of being received is written in a bit map format. As a standard, 1 is written at a bit corresponding to a relative position (off-set) of a beacon reception timing from each communication station, b using the beacon transmission timing of the local station. A bit position corresponding to the relative position of a timing when a beacon is not received remains unchanged to 0.

FIG. 9 shows a description example of NBOI in a case where the number of using channel is one. In the example shown in FIG. 9, the NBOI field notifies that a communication station 0 shown in FIG. 3 “can receive beacons from a communication station 1 and a communication station 9”. A lowermost bit in the NBOI field is assigned to the beacon transmission position of the local station. Referring to the position as a criteria, assignment to a bit corresponding to the relative position (offset) of a receivable beacon of the neighbor station is carried out as in: if the beacon has been already received, a mark is assigned to the bit, and if not, a space is assigned. A mark may be assigned to the bit corresponding to the timing that the beacon is not still received, for the purposes other than the above description. In the present embodiment, the NBOI information describing the beacon arrangement regarding each available frequency channel is required and description regarding this point will be made later.

After mutually receiving beacon signals on a certain channel, in accordance with NBOI contained in each beacon signal, each communication station can arrange its own beacon transmission timing so as to avoid a collision of the beacon on each of usable frequency channels and can detect the beacon reception timing from a neighboring station.

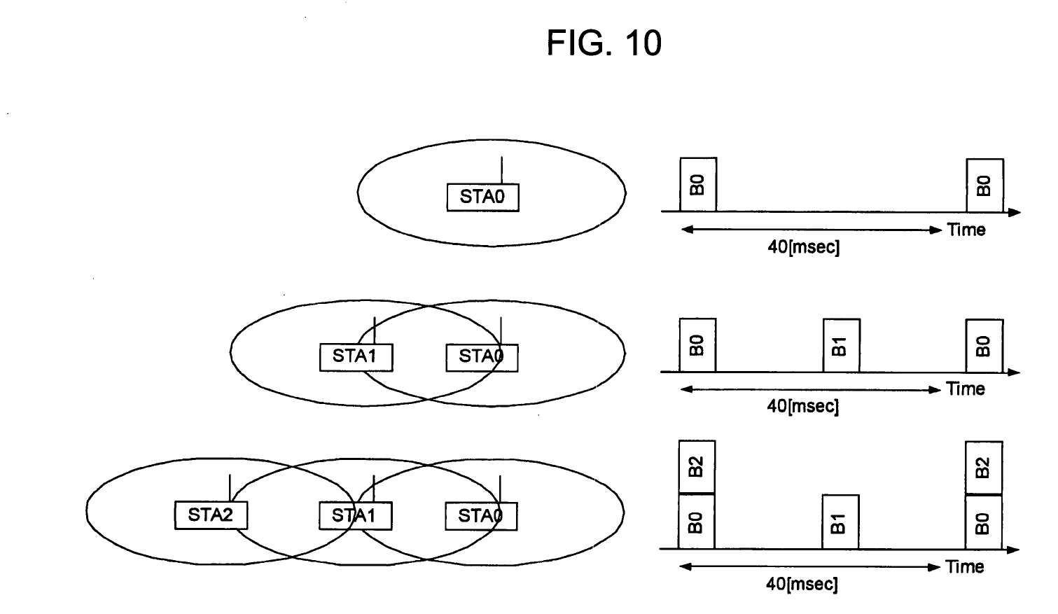

FIG. 10 shows how a newly participating station arranges its own beacon transmission timing on a certain frequency channel in accordance with the description in NBOI, while avoiding a collision with already existing beacons. Each stage shown in FIG. 10 indicates an entry state of communication stations STA0 to STA2. The left side of each stage indicates an arrangement state of each communication station and the right side indicates an arrangement of beacons transmitted from the stations.

The uppermost stage shown in FIG. 10 shows that only the communication station STA0 exists. STA0 tries to receive a beacon but cannot receive it so that it sets a proper beacon transmission timing and can start transmitting a beacon when this timing comes. A beacon is transmitted every 40 ms (transmission frame). All bits in the NBOI field described in the beacon transmitted from STA0 are 0.

The middle stage shown in FIG. 10 shows that STA1 enters within the communication range of the communication station STA0. STA1 tries to receive a beacon and receives the beacon from STA0. Since all bits in the NBOI field other than the bit corresponding to own transmission timing are 0, own beacon transmitting timing is set substantially at the middle of the beacon interval of STA0 in accordance with the above-described process procedure.

In the NBOI field of the beacon transmitted from STA1, 1 is set to the bit representative of own transmission timing and the bit representative of a reception timing of the beacon from STA0, and 0 is set to all other bits. As STA0 recognizes the beacon from STA1, 1 is set to the corresponding bit position of the NBOI field.

The lowermost stage shown in FIG. 10 shows that STA2 enters the communication range of the communication station STA1. In the example shown in FIG. 10, STA0 is a hidden terminal relative to STA2. Therefore, STA2 cannot recognize that STA1 receives the beacon from STA0 so that as shown in the right side, there is a possibility that STA2 transmits the beacon at the same timings as those of STA0 and a collision occurs.

The NBOI field is used to avoid this phenomenon. In the NBOI field of the beacon of STA1, 1 is set to, in addition to the bit representative of the transmission timing of the local station, the bit representative of the beacon transmission timing of STA0. Although STA2 cannot directly receive the beacon transmitted from the hidden terminal STA0, STA2 recognizes the beacon transmission timing of STA0 from the beacon received from STA1 and evades the beacon transmission at this timing.

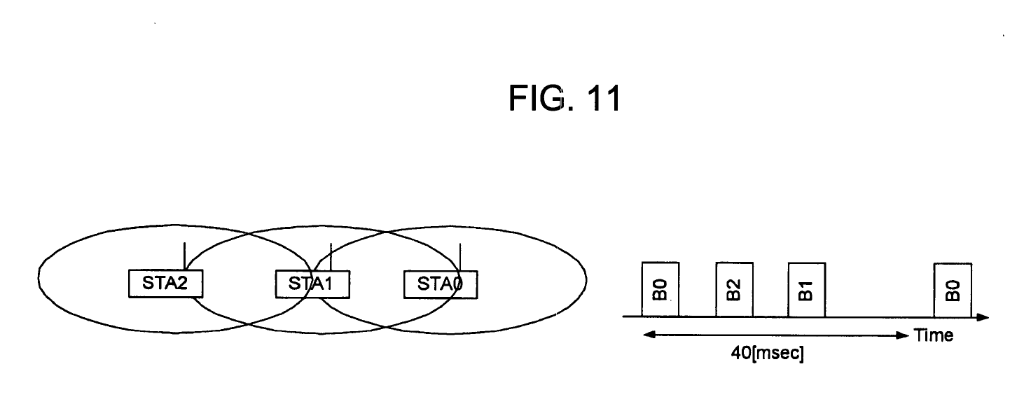

As shown in FIG. 11, STA2 sets the beacon transmission timing at approximately the middle of the beacon interval of STA0 and STA1. Obviously, in NBOI of the beacon transmitted from STA2, 1 is set to the bits representative of the beacon transmission timings of STA2 and STA1. With the beacon collision avoiding function based upon the description in the NBOI field, the beacon position of the hidden terminal, i.e., the neighbor station two stations ahead can be grasped and a beacon collision can be avoided.

C. Efficient Setting of Transmission Pause Period

As described above, in a self-organized distribution type wireless communication system, each communication station notifies beacon information in the transmission frame period and beacon signals from other stations are scanned so that the network configuration on a single channel can be recognized. In addition, the RTS/CTS method is adopted as means for avoiding a collision to improve communication quality and a neighboring station which received the RTS or CTS can evade a collision by setting a transmission pause period for the local station only for a period during which data transmission based on the RTS/CTS procedure is expected.

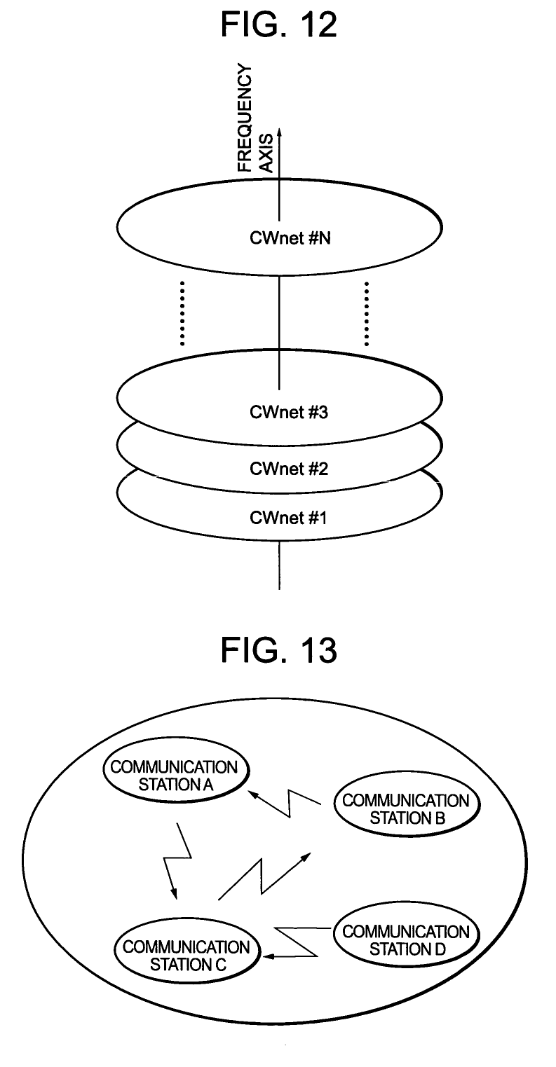

In a case of the multi-channel self-organized distribution type network of this embodiment, however, the transmission frames such as shown in FIG. 4 corresponding in number to the number of usable channels are disposed on the frequency axis (refer to FIG. 12). Therefore, in the multi-channel communication environment, in a case where a data transmitting communication station transits to a beacon transmission channel of a data transmission destination communication station to carry out a data transmission operation, there arises an inherent hidden terminal problem that, if the transition destination channel is an interference channel for a neighbor station being a hidden terminal relative to the data transmission destination communication station, the station cannot hear an RTS signal transmitted through the transition destination channel.

In the self-organized distribution type communication system according to the present embodiment, although a system in which information regarding whether the beacon reception of the neighbor station is scheduled or not is notified among the neighboring stations, since the beacon of the next neighbor station cannot be received, information as to when the beacon was actually transmitted, whether or not the channel is to be changed after the beacon transmission, or the like cannot be found. Here, in a case where carrier sensing is continued until the transmission time of the CTS signal which is the latest within a predictable range and a maximum length transmission pause period is provided, the transmission is paused more than necessary so that the throughput is deteriorated.

Accordingly, in the present invention, taking the beacon channels and the data channels into consideration, the transmission pause period is effectively provided so as to improve the efficiency of the network operation and to realize improvement of the throughput.

C-1. Neighbor Apparatus Information in a Multi-Channel Communication Environment

In the present embodiment, each communication station considers the channels of the beacon and the data to set an efficient transmission period. Accordingly, it is necessary for the communication station to acquire neighbor station information including the beacon transmission timing and the like in each available channel.

In a case of a single channel self-organized distribution type system, it is possible for each communication station to arrange its beacon transmission timing while avoiding a collision and to detect the beacon reception timing of the neighboring stations (including the neighbor stations and the next neighbor stations) by notifying NBOI information as shown in FIG. 9 included in the beacon signal (described above). Here, a structure in which each communication station acquires neighbor apparatus information in the multi-channel communication system will be described.

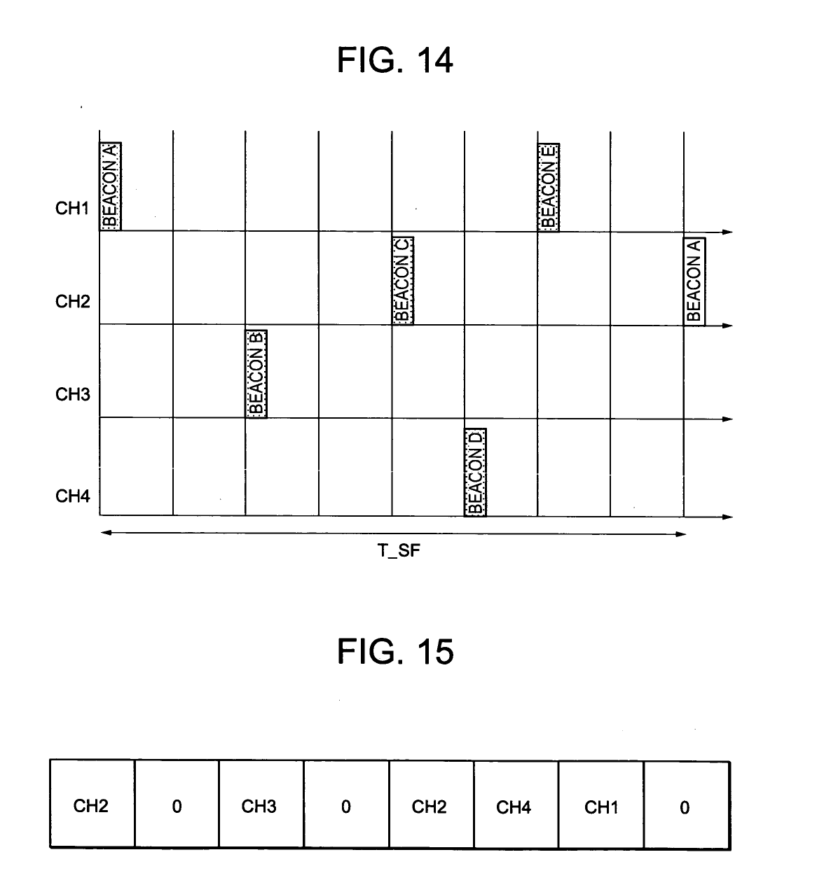

Here, a case where only four communication stations A-D are present in a communication range and a communication station A selects a transmission channel in a multi-channel communication system composed of four channels of channel 1 to channel 4, as shown in FIG. 13, is considered. And, it is assumed that the communication stations A-D arrange the beacon transmission timing on each channel as shown in FIG. 14.

As shown in FIG. 14, each of the communication stations A-D arranges its beacon transmission timing in a mutually shifted manner so as not to collide with a beacon from the other stations. In addition, the channel through which a beacon is transmitted and received is set for each communication station on the basis of the channel quality information in the neighboring station, respectively.

If the smallest step of a beacon interval of each terminal is T_SF/8, in a case of the beacon transmission time and relative channel arrangement as shown in FIG. 14, it can be grasped as beacon position information described as shown in FIG. 15.

In an example shown in FIG. 15, the beacon position information has columns in the number of beacons which can be arranged within a transmission frame period T_SF. The head column is assigned to a beacon transmission position of the local station, and a beacon transmission channel is written therein. Each column subsequent thereto is assigned at the transmission time of every T_SF/8 using the beacon transmission position of the local station as a criterion, and the channel information of a beacon received at a relative position (offset) corresponding to the beacon transmission position of the local station is written therein.

The beacon position information as shown in FIG. 15 has information regarding whether or not a beacon of the transmission time matching each column and, if there exists the beacon, information regarding the channel written therein, and the beacon position information corresponds to neighbor communication apparatus information NBOI in the multi-channel communication environment. Each communication station creates beacon location information on the basis of the beacon which the local station could receive on each channel and write the information in the beacon to mutually notify to the neighboring stations so that it is possible for each communication station to grasp the neighbor communication environment. In addition, each communication station fetches the beacon position information from the received beacon to update the content of the beacon position information in the local station.

The communication station obtains the beacon transmission channel in each transmission frame period on the basis of the description content of such beacon position information and switches to the obtained channel at the beacon transmission/reception time so as to try transmission/reception.

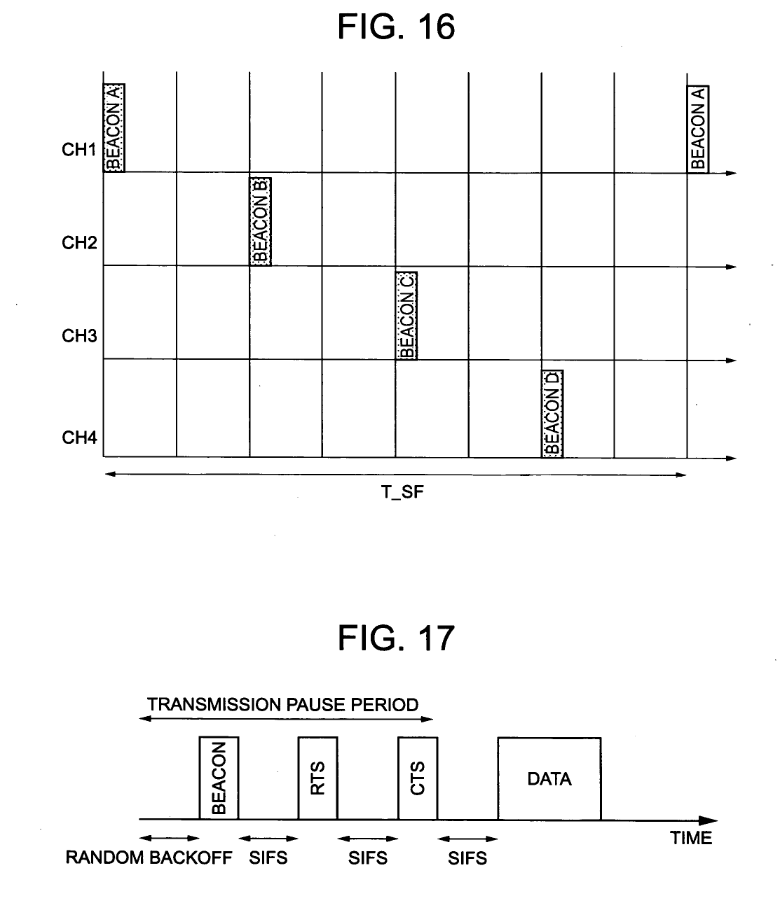

It is preferable that relative channel arrangement of the beacon is made so that the transmission time of each beacon is positioned as far as possible with each other. This is because, since data transmission in the transmission prioritized period (TPP) acquired after the beacon transmission/reception is carried out on the channel of the beacon, time capable of communication can be longer if the beacons are separated as far as possible. FIG. 16 shows an example of beacon arrangement of each communication channel on the multiple channels.

C-2. Transmission Pause Period Setting Method 1

The communication station carries out a scan operation periodically on all the channels so that it can grasp information of a transmission position and a transmission channel of a beacon of a neighbor terminal. For example, in a case where each station transmits a beacon through the channel and at the timing as shown in FIG. 14, each communication station can grasp the neighbor apparatus information as shown in FIG. 15 (note that FIG. 15 shows an example that the communication station A acquires the information) (described above).

Each communication station transmits the neighbor apparatus information that the local station acquired as a part of the beacon information and notifies the neighbor station of the information. The beacon arranged at each beacon transmission position of ever T_SF/8 is not separated between the neighbor station and the next neighbor station in the neighbor apparatus information shown in FIG. 15. However, it is possible for the communication station to determine, depending on whether the communication station could actually receive a beacon at a reception scheduled time of a beacon from a neighboring station, whether the beacon is of the neighbor station or the next neighbor station. In other words, it is possible to find the time of the beacon reception from the neighbor station. On the other hand, in a case where a beacon to receive is positioned at a transmission position where the communication station cannot hear the beacon, it is found that the beacon is of the next neighbor station, that is, of a hidden terminal relative to the local station.

The communication station sets the period pausing the transmission to have different lengths in accordance with a result of judgment on whether the beacon to receive is from the neighbor station or the next neighbor station in this way. For avoiding a collision due to the hidden terminal, the transmission is suspended from time when the beacon transmission is expected until time reception of a CTS signal for data transmission/reception transmitted subsequent to the beacon is expected. Each length of the transmission pause period is determined as follows:

(1) A Case where a Beacon to Receive is of the Neighbor Station

Each communication station transmits a beacon signal at a timing to which a predetermined random backoff is added when a beacon transmission position of the local station comes in a transmission frame period T_SF.

A communication station waiting for beacon reception actually hears the beacon, in a case where the beacon is transmitted from the neighbor station, to confirm a beacon reception timing regardless of a random backoff value. And, the communication station is able to receive a transmission signal from the neighbor station, such as an RTS, subsequent to the beacon.

Here, in a case where the CTS sent back immediately after the RTS signal is heard, the transmission should be paused for a transmission time period defined in the CTS signal because of the possibility of a data portion collision. On the other hand, if the CTS sent back immediately after the RTS signal is not heard, it is found that there is no possibility of the data portion collision, and the transmission may be started. The transmission pause period of this case is as shown in FIG. 17.

(2) A Case where a Beacon to Receive is of the Next Neighbor Station

Each communication station transmits a beacon signal at a timing to which a predetermined random backoff is added when a beacon transmission position of the local station comes in a transmission frame period T_SF.

In a case where the data is transmitted from the next neighbor station, a communication station waiting for beacon reception cannot receive the beacon actually so that it is necessary to estimate a maximum value for the transmission pause period for avoiding a collision with the data portion.

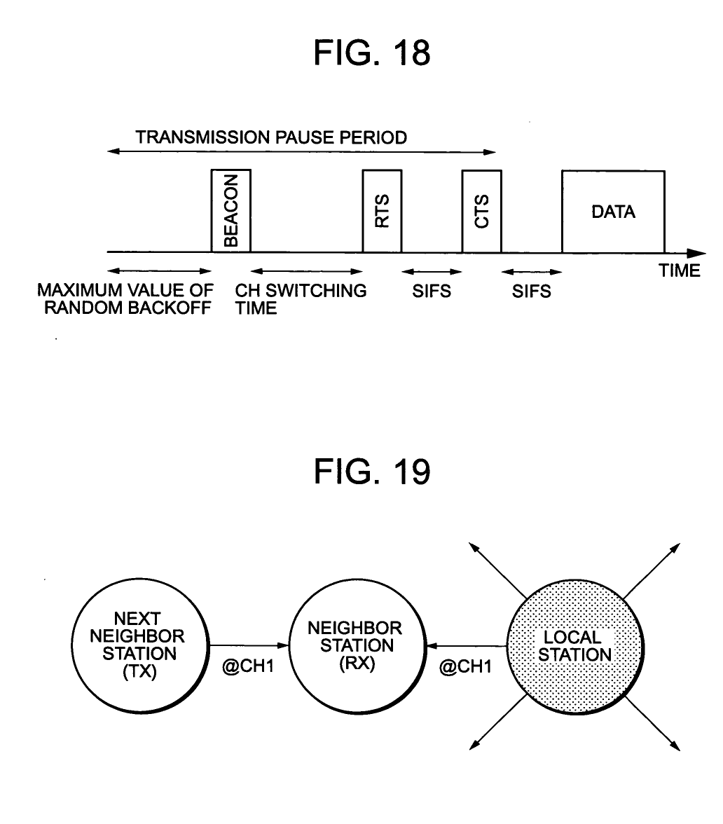

Here, the beacon is considered to be transmitted at the latest timing by a random backoff. Moreover, transmission of the data portion may possibly carried out through another channel, and in that case, it is necessary to wait for a time period required for switching channels. Thereafter, the RTS is transmitted and the CTS is returned. The transmission is paused until that time, and then, the communication station tries to receive the CTS. The transmission pause period of this case is as shown in FIG. 18. As described above, at the beacon transmission time of the next neighbor station, the transmission pause period becomes longer than the case of the beacon of the neighbor station.

C-3. Transmission Pause Period Setting Method 2

Similar to the case described in C-2, the communication station is able to grasp information of a transmission position and a transmission channel of a beacon of the neighbor terminal by carrying out, for example, a scan operation on all the channels periodically. For example, in a case where each station transmits a beacon through the channel and at the timing as shown in FIG. 14, each communication station can grasp the neighbor apparatus information as shown in FIG. 15.

In C-2, the transmission pause period is set depending on whether the communication station received the beacon to receive or not. However, here, whether or not the transmission pause period is set is judged in accordance with the neighbor apparatus information as shown in FIG. 15.

In a case where the beacon to be transmitted is a beacon of the next neighbor station, it is not possible to actually receive the beacon. However, if the transmission is started carelessly, the beacon becomes an interference signal from a hidden terminal relative to the neighbor station receiving the beacon of the next neighbor station so that the beacon reception is interrupted. The example shown in FIG. 19 shows a state where the communication station carries out data transmission on the channel 1 and interferes the data reception of the neighbor station when the neighbor station receives data from the next data station on the channel 1.

Thus, the communication station refers to neighbor apparatus information described in a beacon received from a neighbor station to judge whether or not a beacon transmission channel of a corresponding next neighbor station matches a transmission scheduled channel of its own. In a case where these channels match, a transmission pause period for the next neighbor station is provided and the transmission is postponed. Accordingly, blocking of the beacon reception from the next neighbor station by the neighbor station can be avoided and provision of an unnecessary transmission pause period is not required so that the throughput is improved.

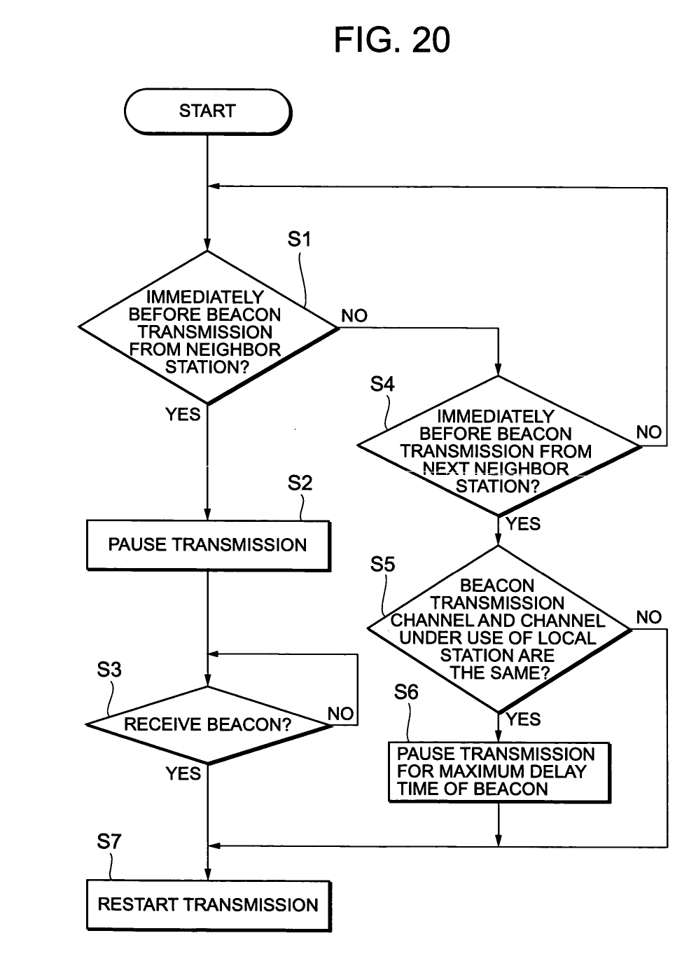

A processing procedure for setting the transmission pause period in accordance with a scheduled beacon reception from the neighboring station performed by the communication station is shown in a form of a flowchart in FIG. 20. The processing is actually implemented by the central control unit 103 executing an execution command program stored in the information storage unit 113 in the wireless communication apparatus 100 operating as the communication station.

In response to that the beacon transmission scheduled time of the neighbor station comes (Step S1), the communication station stops transmission (Step S2), and waits to receive the beacon (Step S3).

In addition, in response to that the beacon transmission scheduled time of the next neighbor station comes (Step S4), the communication station checks whether the beacon transmission channel matches the data transmission channel of the local station (Step S5).

Herein, in a case where the channels match each other, a transmission pause period is set with the maximum delay time until the beacon arrives in mind to avoid a collision (Step S6).

After the reception of the beacon of the neighbor station or after the lapse of a pause period for the next neighbor station transmitting the beacon, the transmission operation of the local station is restarted (Step S7).

C-4. Transmission Pause Period Setting Method 3

Similar to the case described in C-2, the communication station is able to grasp information of a transmission position and a transmission channel of a beacon of the neighbor terminal by carrying out, for example, a scan operation on all the channels periodically. For example, in a case where each station transmits a beacon through the channel and at the timing as shown in FIG. 14, each communication station can grasp the neighbor apparatus information as shown in FIG. 15.

It is assumed here that the channel is changed immediately after the beacon transmission and the data transmission can be carried out through another channel. In this case, the beacon from the next neighbor station cannot be received directly, and it is not possible to know whether the data transmission channel is changed or not. Accordingly, if the communication station starts transmission carelessly, there may be a case where the transmitted data become an interference wave against the neighbor station receiving data from the next neighbor station through the same channel. Therefore, at the beacon reception scheduled time of the next neighbor station, it is necessary to provide a transmission pause period unconditionally regardless of channel set as the beacon transmission channel.

In order to avoid setting the transmission pause period which is unnecessarily long like the above, here, information indicating presence or absence of the data transmission channel change (hereinafter, called “data channel change possibility information” is further added as information described in the beacon.

The data channel change possibility information is described at a position corresponding to each beacon transmission position similarly to the neighbor apparatus information indicating the beacon transmission position and the channel of the neighboring stations (see FIG. 15). In other words, the data channel change possibility information has columns in the number of beacons which can be arranged within a transmission frame period T_SF. A head column thereof indicates a value of 1 or 0 to show the channel change possibility of the local station. Each column subsequent thereto is assigned at the transmission time of every T_SF/8 using the beacon transmission position of the local station as a criterion, and the channel change possibility in the neighboring station to which the beacon transmission is scheduled is shown with the value 1 or 0 at a relative position (offset) corresponding to the beacon transmission position of the local station.

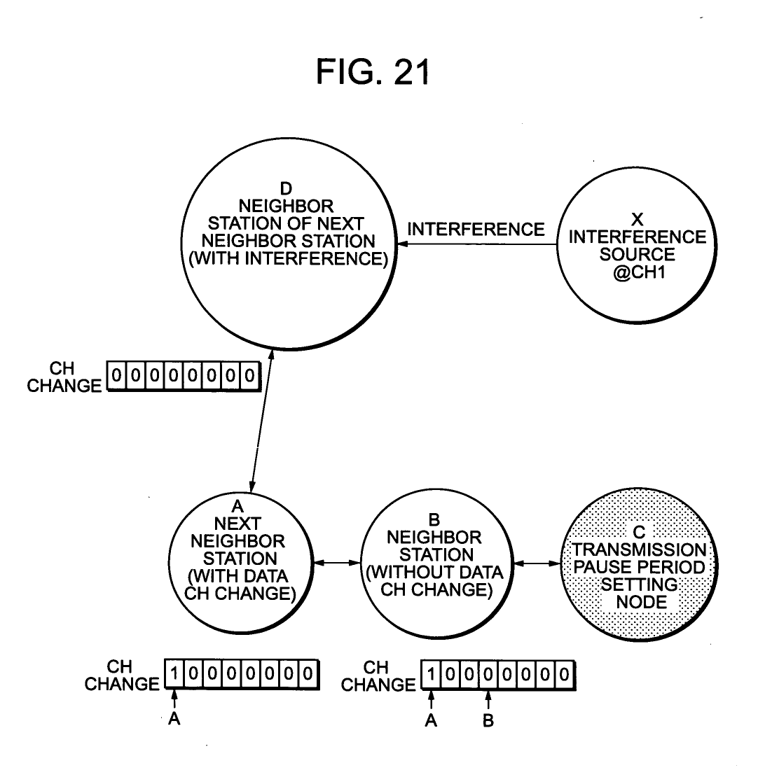

FIG. 21 illustrates a system for setting the transmission pause period on the basis of data channel change possibility information performed by the communication station.

In the example shown in FIG. 21, the communication station D is interfered by an interference source X. As a result, although the communication station D can barely receive the beacon, the data received through the channel has a lot of errors and a fast rate cannot be employed. Thus, the communication station A which carries out transmission to the communication station D switches the channel for data transmission. Information indicating the possibility of this channel change is the data channel change possibility information (CH Change) shown below the communication station A in FIG. 21, the column corresponding to the beacon position of the communication station A itself is set to 1.

Such data channel change possibility information is notified as a part of the beacon information to the neighbor station. Each communication station counts the received beacon to acquire the information indicating presence or absence of the data channel change of each neighboring station so that the acquired information is described as data channel change possibility information (CH Change) other than the beacon position of the local station.

The communication station C refers to the data channel change possibility information (CH Change) contained in the beacon from the communication station B and detects possibility that the data channel is changed at the beacon transmission position of the communication station A which is the next neighbor station for the local station.

Accordingly, since there is a possibility that the local station becomes the hidden terminal to interfere the reception of the communication station B at the beacon transmission time to which the data channel change possibility is indicated, the communication station C sets a maximum transmission pause period including a maximum time of the random backoff and time required for the RTS/CTS procedure in addition to the beacon reception scheduled time and stands ready for data transmission until when there is no possibility that the CTS from the communication station B is received.

On the other hand, at the beacon transmission scheduled time of the other next neighbor station having no data channel change possibility, if the beacon transmission channel is different from the data transmission channel of the local station, there is no possibility of a collision at the time of data transmission and it becomes unnecessary for the communication station C to set the transmission pause period.

In this way, notifying to the neighbor station of the information indicating the possibility of data transmission channel change may omit the transmission pause period in some cases. As a result, data transmission possible time is increased and throughput of the whole system is improved.

The present invention has been described in detail with reference to particular embodiments. However, it is obvious that the person skilled in the art can make modifications and alternatives of the embodiments without departing from the gist of the present invention. Namely, the present invention has been disclosed illustratively, and the contents described in the specification should not be construed limitedly. In order to judge the gist of the present invention, claims described below should be considered.

1. A system for forming a network for a plurality of wireless communication apparatuses in a self-organized distributed manner without having a relationship of a controlling station and a controlled station, in a communication environment provided with a plurality of channels, wherein each communication station sets a transmission pause period in accordance with whether a neighboring station is a neighbor station or a next neighbor station and in accordance with a channel used for transmission from the neighboring station at a transmission scheduled time of the neighboring station.

2. The wireless communication system according to claim 1, wherein each communication station transmits a beacon signal at different transmission timings within a predetermined transmission frame period on a beacon transmission channel selected from said plurality of channels.

3. The wireless communication system according to claim 2, wherein each communication station transmits the beacon signal with neighbor apparatus information regarding a beacon transmission channel and a beacon transmission timing from the neighboring station included therein.

4. The wireless communication system according to claim 2, wherein each communication station determines, depending on whether the communication station could actually hear the beacon at a beacon reception scheduled time from the neighboring station, whether a communication station which transmitted the beacon is the neighbor station or the next neighbor station.

5. The wireless communication system according to claim 1, wherein each communication station acquires a transmission prioritized period immediately after the beacon transmission of a local station, transmits a transmission request packet RTS to a data transmission destination, and starts data transmission in response to reception of a confirmation notice packet CTS from the communication station of the data transmission destination.

6. The wireless communication system according to claim 5, wherein each communication station sets a time period after reception of a beacon from the neighbor station until a reception scheduled time of the CTS as a transmission pause period if the communication station receives no CTS signal from the data transmission destination after receiving the RTS signal from the neighbor station.

7. The wireless communication system according to claim 5, wherein each communication station sets a maximum transmission pause period including a maximum time of a random backoff and time required for an RTS/CTS procedure in addition to a beacon reception scheduled time in association with a scheduled beacon reception of the next neighbor station.

8. The wireless communication system according to claim 3, wherein each communication station sets the transmission pause period in accordance with whether or not a beacon transmission scheduled channel of the next neighbor station matches with a data transmission scheduled channel of a local station at a beacon reception scheduled time of the next neighbor station.

9. The wireless communication system according to claim 1, wherein each communication station is allowed to acquire a transmission prioritized period immediately after a beacon transmission of a local station and to change a beacon transmission channel to carry out data transmission.

10. The wireless communication system according to claim 9, wherein each communication station mutually notifies of data channel change possibility information describing possibility that the local station and/or the neighboring station changes the beacon transmission channel to carry out the data transmission.

11. The wireless communication system according to claim 9, wherein the communication station sets a maximum transmission pause period including a maximum time of a random backoff and time required for an RTS/CTS procedure in addition to a beacon reception scheduled time in association with a scheduled beacon reception of the next neighbor station which has a data channel change possibility.

12. A wireless communication apparatus operating in a self-organized distributed manner in a communication environment provided with a plurality of channels, comprising:
communications means for transmitting/receiving wireless data on each channel;
communication channel setting means for setting a transmission channel for a transmission signal of a local station in said communication means;
control means for controlling a communication operation by said communication means on the channel set by said communication channel setting means, wherein:
said control means sets a transmission pause period in accordance with whether a neighboring station is a neighbor station or a next neighbor station and in accordance with a channel used for transmission from the neighboring station at a transmission scheduled time of the neighboring station.

13. The wireless communication apparatus according to claim 12, further comprising:
beacon signal generation means for generating a beacon signal describing information regarding the local station; and
beacon signal analysis means for analyzing the beacon signal received by said communication means from the neighbor station, wherein:
said channel setting means sets a beacon transmission channel from among said plurality of channels, and said control means controls beacon transmission at a beacon transmission timing different from that of the neighboring station within a predetermined transmission frame period.

14. A wireless communication method for operating in a self-organized distributed manner in a communication environment provided with a plurality of channels, comprising:
a communication channel setting step for setting a transmission channel for a transmission signal of a local station; and
a control step for controlling a communication operation on the channel set in said communication channel setting step, while setting a transmission pause period on in accordance with whether a neighboring station is a neighbor station or a next neighbor station at a transmission scheduled time of the neighboring station and in accordance with a channel used at a transmission time of the neighboring station.

15. The wireless communication method according to claim 14, further comprising:
a beacon signal generation step for generating a beacon signal describing information regarding the local station; and
a beacon signal analysis step for analyzing the beacon signal received by said communication means from the neighbor station, wherein:
a beacon transmission channel is set from among said plurality of channels in said channel setting step, and beacon transmission at a beacon transmission timing different from that of the neighboring station is controlled within a predetermined transmission frame period in said control step.

16. The wireless communication method according to claim 15, wherein neighbor apparatus information regarding a beacon transmission channel and a beacon transmission timing of the neighboring station is described in the beacon in said beacon signal generation step.

17. The wireless communication method according to claim 15, wherein depending on whether the communication station could actually hear the beacon at a beacon reception scheduled time from the neighboring station, whether a station which transmitted the beacon is the determined in said control step.

18. The wireless communication method according to claim 14, wherein the communication station is controlled to acquire a transmission prioritized period immediately after the beacon transmission of the local station, to transmit a transmission request packet RTS to a data transmission destination, and to start data transmission in response to reception of a confirmation notice packet CTS from the communication station of the data transmission destination in said control step.

19. The wireless communication method according to claim 18, wherein a time period after reception of a beacon from the neighbor station until a reception scheduled time of the CTS is set as a transmission pause period if the communication station receives no CTS signal from the data transmission destination after receiving the RTS signal from the neighbor station in said control step.

20. The wireless communication method according to claim 18, wherein a maximum transmission pause period including a maximum time of a random backoff and time required for an RTS/CTS procedure in addition to a beacon reception scheduled time is set in association with a scheduled beacon reception of the next neighbor station in said control step.

21. The wireless communication method according to claim 16, wherein a transmission pause period is set in accordance with whether or not a beacon transmission scheduled channel of the next neighbor station matches a data transmission scheduled channel of the local station at a beacon reception scheduled time of the next neighbor station.

22. The wireless communication method according to claim 14, wherein the communication station is allowed to acquire a transmission prioritized period immediately after the beacon transmission of the local station and to change a beacon transmission channel to carry out the data transmission is said control step.

23. The wireless communication method according to claim 22, wherein data channel change possibility information describing possibility that the local station and/or the neighboring station changed the beacon transmission channel to carry out the data transmission is described in the beacon in said beacon signal generation step.

24. The wireless communication method according to claim 14, wherein a maximum transmission pause period including a maximum time of a random backoff and time required for an RTS/CTS procedure in addition to a beacon reception scheduled time is set in association with a scheduled beacon reception of the next neighbor station which has a data channel change possibility in said control step.

25. A computer program written in a computer readable format so as to execute a wireless communication processing on a computer system in a self-organized distributed manner in a wireless communication environment provided with a plurality of channels, comprising:
a communication channel setting step for setting a transmission channel for a transmission signal of a local station; and
a control step for controlling a communication operation on the channel set in said communication channel setting step, while setting a transmission pause period in accordance with whether a neighboring station is a neighbor station or a next neighbor station at a transmission scheduled time of the neighboring station and in accordance with a channel used at a transmission time of the neighboring station.
